(19) United States
(12) Patent Application Publication
(10) Pub. No.: US 2023/0269573 A1
(43) Pub. Date: Aug. 24, 2023

(54) SYSTEMS AND METHODS FOR UE CONTEXT MANAGEMENT IN SIDELINK RELAY SCENARIOS

(71) Applicant: Telefonaktiebolaget LM Ericsson (publ), Stockholm (SE)

(72) Inventor: Antonino Orsino, Kirkkonummi (FI)

(21) Appl. No.: 18/017,892

(22) PCT Filed: Jul. 30, 2021
(86) PCT No.: PCT/IB2021/057005

§ 371 Date: Jan. 25, 2023

Related U.S. Application Data
(60) Provisional application No. 63/058,915, filed on Jul. 30, 2020.

(51) Int. Cl. H04W 8/02

(52) U.S. Cl. CPC H04W 8/02; H04W 88/04

(57) ABSTRACT

Systems and methods of the present disclosure are directed to a method performed by a User Equipment (UE) for context management in a sidelink relay scenario. The method includes initiating a Radio Access Network (RAN) Notification Area (RNA) update with a managing network node. The method includes sending UE identities for a sidelink relay to the managing network node. The UE identities comprises both a Remote (RM) UE identity of a RM UE in the sidelink relay and a Relay (RL) UE identity of a RL UE in the sidelink relay. The UE is either the RM UE or the RL UE.

### RELATED APPLICATIONS

This application claims the benefit of provisional patent application serial number 63/058,915, filed Jul. 30, 2020, the disclosure of which is hereby incorporated herein by reference in its entirety.

### TECHNICAL FIELD

The present disclosure relates to context management in a sidelink relay scenario.

### BACKGROUND

### Vehicle-to-Everything (V2X)

Rel-14 and Rel-15 of the Third Generation Partnership Project (3GPP) define extensions for device-to-device work including support of Vehicle-to-Everything (V2X) communication for Fourth Generation (4G) Long Term Evolution (LTE) and Fifth Generation (5G) New Radio (NR) mobile wireless communications systems. V2X communication includes any combination of direct communication between vehicles, pedestrians, and infrastructure. V2X communication may take advantage of a network infrastructure, when available, but at least basic V2X connectivity should be possible even in case of lack of coverage. Providing an LTE-based V2X interface may be economically advantageous because of the LTE economies of scale inherent to LTE networks, and may further enable tighter integration of communications between network infrastructure, a vehicle, pedestrian(s), and/or other vehicle(s), as compared to using a dedicated V2X technology (e.g., the Institute of Electrical and Electronics Engineers (IEEE) 802.11p).

FIG. 1 is a schematic diagram illustrating V2X scenarios for an LTE-based network. V2X communications may carry both non-safety and safety information, where each of the applications and services may be associated with specific requirements sets, e.g. in terms of latency, reliability, data rates etc. There are several different use cases defined for V2X:
Vehicle-to-Vehicle (V2V): covering LTE-based communication between vehicles, either via the cellular interface (known as Uu) or via the sidelink interface (known as PC5).
Vehicle-to-Pedestrian (V2P): covering LTE-based communication between a vehicle and a device carried by an individual (e.g., handheld terminal carried by a pedestrian, cyclist, driver, or passenger), either via Uu or sidelink interface (PC5)
Vehicle-to-Infrastructure/Network (V2I/N): covering LTE-based communication between a vehicle and a roadside unit/network. A Roadside Unit (RSU) is a transportation infrastructure entity (e.g., an entity transmitting speed notifications) that communicates with V2X capable User Equipment (UE) over sidelink (PC5) or over Uu. For V2N, the communication is performed on Uu.

### NR V2X Enhancements

3GPP SA1 working group has completed new service requirements for future V2X services in the Function-Specific (FS) enhanced V2X (eV2X). SA1 have identified 25 use cases for advanced V2X services which will be used in 5G (i.e., LTE and NR). Such use cases are categorized into four use case groups: vehicles platooning, extended sensors, advanced driving, and remote driving. Direct unicast transmission over sidelink will be needed in some use cases, such as platooning, cooperative driving, dynamic ride sharing, etc. For these advanced applications, the expected requirements to meet the needed data rate, capacity, reliability, latency, communication range, and speed are more stringent. The consolidated requirements for each use case group are captured in Technical Report (TR) 22.886.

### NR Rel. 17 Work on Sidelink

In 3GPP Rel. 17, as discussions are being held, National Security and Public Safety (NSPS) has emerged as an important use case that can benefit from the already developed NR sidelink features in Rel.16. Therefore, it is likely that 3GPP will specify enhancements related to NSPS use-case(s) that take NR Rel. 16 sidelink as a baseline. Additionally, in some scenarios, NSPS services need to operate with partial network coverage or even without network coverage (e.g., indoor firefighting, forest firefighting, earthquake rescue, sea rescue, etc.), where network infrastructure is (partially) destroyed or not available. Therefore, coverage extension is a crucial enabler for NSPS, for both NSPS services communicated between UE and cellular network and that communicated between UEs over sidelink. In Rel.17, a new Study Item Description (SID) on NR sidelink relay (RP-193253) is described which aims to further explore coverage extension for sidelink-based communication, including both UE to network relay for cellular coverage extension and UE to UE relay for sidelink coverage extension.

### L1/12 Id

Sidelink transmissions are associated with a source Radio Layer 1 (L1)/Radio Layer 2 (L2) Identifier (ID) and a destination L1/L2 ID. For sidelink unicast, source L1/L2 ID represents the service type and/or transmitter UE ID, which will become the destination L1/L2 ID of the peer UE. A sidelink unicast link is identified by the combination of source L1/L2 ID and destination L1/L2 ID. For sidelink groupcast, source L1/L2 ID represents the transmitter UE ID, and destination L1/L2 ID represents the group identifier provided by the upper layer or the service type. For sidelink broadcast, source L1/L2 ID represents the transmitter UE ID, and destination L1/L2 ID represents the service type. A connected UE will report the destination L2 ID to its serving cell/node.

### Tracking Area Update in NR

A UE needs to register with the network to get authorized to receive services, to enable mobility tracking, and to enable reachability. The UE initiates the Registration procedure using one of the following Registration types:
Initial Registration to the 5G System (5GS);
Mobility Registration Update upon changing to a new Tracking Area (TA) outside the UE’s Registration Area in both CM-CONNECTED and CM-IDLE state, or when the UE needs to update its capabilities or protocol parameters that are negotiated in Registration procedure with or without changing to a new TA, a change in the UE’s Preferred Network Behaviour that would create an incompatibility with the Supported Network Behaviour provided by the serving Access and Mobility Management Function (AMF), or when the UE intends to retrieve Local Area Data Network (LADN) Information;
Periodic Registration Update (due to a predefined time period of inactivity); or
Emergency Registration.

FIG. 2 is a flow diagram of a General Registration procedure, reproduced from clause 4.2.2.2.2 of Technical Specification (TS) 23.502. The General Registration call flow in clause 4.2.2.2.2 applies on all these Registration procedures, but the periodic registration need not include all parameters that are used in other registration cases.

The following are the cleartext Information Elements (IEs), as defined in TS 24.501 that can be sent by the UE in the Registration Request message if the UE has no Non-Access Stratum (NAS) security context:
Registration type;
Subscription Concealed Identifier (SUCI) or 5G-Globally Unique Temporary Identifier (GUTI) or Permanent Equipment Identifier (PEI);
Security parameters;
additional GUTI;
4G TA update; and
the indication that the UE is moving from Evolved Packet System (EPS).

Aspects related to dual registration in 3GPP and non-3GPP access are described in clause 4.12. The general Registration call flow in clause 4.2.2.2.2 is also used for the case of registration in 3GPP access when the UE is already registered in a non-3GPP access, and vice versa. Registration in 3GPP access when the UE is already registered in a non-3GPP access scenario may require an AMF change, as further detailed in clause 4.12.8.

The general Registration call flow in clause 4.2.2.2.2 is also used by UEs in limited service state, as described in see TS 23.122, registering for emergency services only (referred to as Emergency Registration), as described in TS 23.501 clause 5.16.4.

During the initial registration, the PEI is obtained from the UE. If the PEI is needed (e.g., for Equipment Identity Register (EIR) check), the AMF shall retrieve the PEI when it establishes the NAS security context with a Security Mode Command during initial registration. The AMF operator may check the PEI with an EIR. If the PEI was retrieved by the AMF (either from the UE or another AMF), AMF shall provide it to the Unified Data Management (UDM) using Nudm_UECM_Registration in order to ensure that the UDM always has the latest PEI available e.g., for reporting event Change of Subscription Permanent Identifier (SUPI)-PEI association. The AMF passes the PEI to the UDM, to the Session Management Function (SMF) and the Policy Control Function (PCF). The UDM may store this data in Unified Data Repository (UDR) by Nudr_SDM_Update.

The use of Network Slice Instance (NSI) ID in the 5G Core (5GC) is optional and depends on the deployment choices of the operator.

During the registration, the Home Network can provide Steering of Roaming information to the UE via the AMF (i.e., a list of preferred Public Land Mobile Network (PLMN)/access technology combinations or Home PLMN (HPLMN) indication that ‘no change of the “Operator Controlled PLMN Selector with Access Technology” list stored in the UE is needed). The Home Network can include an indication for the UE to send an acknowledgement of the reception of this information. Details regarding the handling of Steering of Roaming information including how this information is managed between the AMF and the UE are defined in TS 23.122.

The AMF determines Access Type and Radio Access Technology (RAT) Type as defined in TS 23.501 clause 5.3.2.3.

### RAN Notification Area Update in NR

Radio Access Network (RAN)-Based Notification Area: A UE in the RRC_INACTIVE state can be configured by the last serving Next Generation RAN (NG-RAN) node with a RAN Notification Area (RNA), where:
The RNA can cover a single or multiple cells, and shall be contained within the Core Network (CN) registration area. In current releases, Xn connectivity may be available within the RNA.
An RNA update is periodically sent by the UE, and is also sent when the cell reselection procedure of the UE selects a cell that does not belong to the configured RNA.

There are several different alternatives on how the RNA can be configured:
List of cells:
   A UE is provided an explicit list of cells (one or more) that constitute the RNA.
List of RAN areas:
   A UE is provided at least one RAN area ID, where a RAN area is a subset of a CN TA or equal to a CN TA. A RAN area is specified by one RAN area ID, which consists of a TA Code (TAC) and optionally a RAN area Code.
   A cell broadcasts one or more RAN area IDs in the system information.

NG-RAN may provide different RNA definitions to different UEs, but cannot mix different definitions to the same UE at the same time. The UE generally shall support all RNA configuration options described previously.

RNA update: FIG. 3 is a flow diagram of a UE-triggered RNA update procedure involving context retrieval over Xn. The procedure may be triggered when the UE moves out of the configured RNA, or periodically.

1. The UE resumes from RRC_INACTIVE, providing the Inactive Radio Network Temporary Identifier (I-RNTI) allocated by the last serving NR Base Station (gNB) and appropriate cause value, e.g., RNA update.

2. The gNB, if able to resolve the gNB identity contained in the I-RNTI, requests the last serving gNB to provide UE Context, providing the cause value received in step 1.

3. The last serving gNB may provide the UE context (as assumed in the following). Alternatively, the last serving gNB may decide to move the UE to RRC_IDLE (and the procedure follows steps 3 and later of FIG. 9.2.2.5-3) or, if the UE is still within the previously configured RNA, to keep the UE context in the last serving gNB and to keep the UE in RRC_INACTIVE (and the procedure follows steps 3 and later of FIG. 9.2.2.5-2).

4. The gNB may move the UE to RRC_CONNECTED (and the procedure follows step 4 of FIG. 9.2.2.4.1-1), or send the UE back to RRC_IDLE (in which case an RRCRelease message is sent by the gNB), or send the UE back to RRC_INACTIVE as assumed in the following.

5. If loss of Downlink (DL) user data buffered in the last serving gNB shall be prevented, the gNB provides forwarding addresses.

6./7. The gNB performs path switch.

8. The gNB keeps the UE in RRC_INACTIVE state by sending RRCRelease with suspend indication.

9. The gNB triggers the release of the UE resources at the last serving gNB.

FIG. 4 is a flow diagram of the RNA update procedure for the case when the UE is still within the configured RNA and the last serving gNB decides not to relocate the UE context and to keep the UE in RRC_INACTIVE.

1. The UE resumes from RRC_INACTIVE, providing the I-RNTI allocated by the last serving gNB and appropriate cause value, e.g., RNA update.

2. The gNB, if able to resolve the gNB identity contained in the I-RNTI, requests the last serving gNB to provide UE Context, providing the cause value received in step 1.

3. The last serving gNB stores received information to be used in the next resume attempt (e.g., Cell Radio Network Temporary Identifier (C-RNTI) and Physical Cell Identity (PCI) related to the resumption cell), and responds to the gNB with the RETRIEVE UE CONTEXT FAILURE message including an encapsulated RRCRelease message. The RRCRelease message includes Suspend Indication.

4. The gNB forwards the RRCRelease message to the UE.

FIG. 5 is a flow diagram of the RNA update procedure for the case when the last serving gNB decides to move the UE to RRC_IDLE.

1. The UE resumes from RRC_INACTIVE, providing the I-RNTI allocated by the last serving gNB and appropriate cause value, e.g., RNA update.

2. The gNB, if able to resolve the gNB identity contained in the I-RNTI, requests the last serving gNB to provide UE Context, providing the cause value received in step 1.

3. Instead of providing the UE context, the last serving gNB provides an RRCRelease message to move the UE to RRC_IDLE.

4. The last serving gNB deletes the UE context.

5. The gNB sends the RRCRelease which triggers the UE to move to RRC_IDLE.

### SUMMARY

In some embodiments, a method is performed by a User Equipment (UE) for context management in a sidelink relay scenario. The method includes initiating a Radio Access Network (RAN) Notification Area (RNA) update with a managing network node. The method includes sending UE identities for a sidelink relay to the managing network node. The UE identities comprises both a Remote (RM) UE identity of a RM UE in the sidelink relay and a Relay (RL) UE identity of a RL UE in the sidelink relay. The UE is either the RM UE or the RL UE.

In some embodiments, the RNA update is initiated in response to the UE experiencing a change of RNA

In some embodiments, the RNA update is initiated in response to the UE experiencing a cell reselection for a cell that does not belong to a configured RNA.

In some embodiments, the RM UE is the RL UE, and method further comprises requesting the RM UE identity from the RM UE in the sidelink relay.

In some embodiments, the method further comprises receiving the RM UE identity before sending the UE identities for the sidelink relay to the managing network node.

In some embodiments, initiating the RNA update with the managing network node comprises sending a message to the managing network node comprising an RNA update cause value and at least one of the UE identities.

In some embodiments, the message to the managing network node comprises a Radio Resource Control (RRC)ResumeRequest message.

In some embodiments, the method further comprises sending an additional message to the managing network node comprising another of the UE identities.

In some embodiments, the method further comprises requesting the another of the UE identities from a corresponding UE in the sidelink relay. In some embodiments, the method further comprises receiving the another of the UE identities before sending the additional message to the managing network node.

In some embodiments, the method further comprises generating a UE identity mapping for the UE and one or more RM UE identities corresponding to one or more RM UEs in sidelink relays with the UE.

In some embodiments, sending the UE identities for the sidelink relay to the managing network node comprises sending the UE identity mapping to the managing network node.

In some embodiments, sending the UE identity mapping to the managing network node comprises sending the UE identity mapping periodically.

In some embodiments, sending the UE identity mapping to the managing network node comprises sending the UE identity mapping in response to a triggering event.

In some embodiments, sending the UE identity mapping to the managing network node comprises sending the UE identity mapping in response to receiving a UE identity request from the managing network node.

In some embodiments, initiating the RNA update comprises sending a RRCResumeRequest message to the managing network node.

In some embodiments, the method further comprises requesting the one or more RM UE identities from the one or more RM UEs in the sidelink relays with the UE. In some embodiments, the method further comprises receiving the one or more RM UE identities. In some embodiments, the method further comprises updating the UE identity mapping in response to receiving the one or more RM UE identities.

In some embodiments, the managing network node comprises a New Radio Base Station (gNB).

In some embodiments, the managing network node comprises an Access and Mobility Management Function (AMF).

In some embodiments, a UE for context management in a sidelink relay scenario is adapted to initiate an RNA update with a managing network node. The UE is adapted to send UE identities for a sidelink relay to the managing network node. The UE identities comprises both a RM UE identity of a RM UE in the sidelink relay and a RL UE identity of a RL UE in the sidelink relay. The UE is either the RM UE or the RL UE.

In some embodiments, a UE for context management in a sidelink relay scenario comprises power supply circuitry configured to supply power to the UE. The UE comprises processing circuitry. The processing circuitry is configured to cause the UE to initiate an RNA update with a managing network node. The processing circuitry is configured to cause the UE to send UE identities for a sidelink relay to the managing network node. The UE identities comprises both a RM UE identity of a RM UE in the sidelink relay and a RL UE identity of a RL UE in the sidelink relay. The UE is either the RM UE or the RL UE.

In some embodiments, a method is performed by a network node for context management in a sidelink relay scenario. The method includes receiving UE identities for a sidelink relay between a RM UE, and a RL UE from the RL UE or the RM UE. The method includes receiving an initiation of an RNA update from the RL UE or the RM UE.

In some embodiments, managing a UE context for the sidelink relay using the UE identities in response to the initiation of the RNA update.

In some embodiments, managing the UE context for the sidelink relay using the UE identities comprises sending a retrieve UE context request to a last managing network node serving the RL UE or the RM UE.

In some embodiments, the retrieve UE context request comprises an RNA update cause value and at least one of the UE identities.

In some embodiments, managing the UE context for the sidelink relay using the UE identities further comprises sending an additional retrieve UE context request to the last managing network node comprising another of the UE identities.

In some embodiments, managing the UE context for the sidelink relay using the UE identities further comprises receiving a retrieve UE context response from the last managing network node comprising at least one of an RL UE context for the RL UE or an RM UE context for the RM UE.

In some embodiments, managing the UE context for the sidelink relay using the UE identities further comprises receiving an additional retrieve UE context response from the last managing network node comprising another of the RL UE context for the RL UE and the RM UE context for the RM UE.

In some embodiments, receiving the initiation of the RNA update from the RL UE or the RM UE comprises receiving a message from the RL UE comprising an RNA update cause value and at least one of the UE identities.

In some embodiments, the message from the RL UE comprises a RRCResumeRequest message.

In some embodiments, wherein the method further comprises receiving an additional message from the RL UE comprising an RM UE identity from the RM UE in the sidelink relay.

In some embodiments, receiving the UE identities for the sidelink relay comprises receiving a UE identity mapping for an RL UE identity of the RL UE and one or more RM UE identities of one or more RM UEs in sidelink relays with the RL UE.

In some embodiments, the method further comprises sending a UE identity request to the RL UE. In some embodiments, the method further comprises receiving the UE identity mapping in response to the UE identity request.

In some embodiments, receiving the UE identity mapping comprises receiving the UE identity mapping from the RL UE periodically.

In some embodiments, receiving the initiation of the RNA update from the RL UE comprises receiving a RRCResumeRequest message from the RL UE.

In some embodiments, the network node comprises a gNB.

In some embodiments, the network node comprises an AMF.

In some embodiments, a network node for context management in a sidelink relay scenario is adapted to receive UE identities for a sidelink relay between a RM UE, and a RL UE from the RL UE or the RM UE. The network node is adapted to receive an initiation of an RNA update from the RL UE or the RM UE. The network node is adapted to manage a UE context for the sidelink relay using the UE identities in response to the initiation of the RNA update.

In some embodiments, a network node for context management in a sidelink relay scenario comprises power supply circuitry configured to supply power to the network node. The network node comprises processing circuitry. The processing circuitry is configured to cause the network node to receive UE identities for a sidelink relay between a RM UE, and a RL UE from the RL UE or the RM UE. The processing circuitry is configured to cause the network node to receive an initiation of an RNA. update from the RL UE or the RM UE. The processing circuitry is configured to cause the network node to manage a UE context for the sidelink relay using the UE identities in response to the initiation of the RNA update.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 is a schematic diagram illustrating Vehicle-to-Everything (V2X) scenarios for a Long Term Evolution (LTE) based network;

FIG. 2 is a flow diagram of a General Registration procedure, reproduced from clause 4.2.2.2.2 of Technical Specification (TS) 23.502;

FIG. 3 is a flow diagram of a User Equipment (UE) triggered Radio Notification Area (RNA) update procedure involving context retrieval over Xn;

FIG. 4 is a flow diagram of the RNA update procedure for the case when the UE is still within the configured RNA and the last serving New Radio Base Station (gNB) decides not to relocate the UE context and to keep the UE in RRC_INACTIVE;

FIG. 5 is a flow diagram of the RNA update procedure for the case when the last serving gNB decides to move the UE to RRC_IDLE;

FIG. 6 illustrates one example of a cellular communications system in which embodiments of the present disclosure may be implemented;

FIG. 7 illustrates a wireless communication system represented as a Fifth Generation (5G) network architecture composed of core Network Functions (NFs), where interaction between any two NFs is represented by a point-to-point reference point/interface;

FIG. 8 illustrates a 5G network architecture using service-based interfaces between the NFs in the Control Plane (CP), instead of the point-to-point reference points/interfaces used in the 5G network architecture of FIG. 7;

FIG. 9 is a flow diagram illustrating operation of the cellular communications system of FIG. 6 in accordance with at least some of the embodiments described above;

FIG. 10 is a flow diagram illustrating operation of the cellular communications system of FIG. 6 in accordance with at least some of the embodiments described above;

FIG. 11 is a schematic block diagram of a network node according to some embodiments of the present disclosure;

FIG. 12 is a schematic block diagram that illustrates a virtualized embodiment of a network node according to some embodiments of the present disclosure;

FIG. 13 is a schematic block diagram of a network node according to some other embodiments of the present disclosure;

FIG. 14 is a schematic block diagram of a wireless communication device according to some embodiments of the present disclosure;

FIG. 15 is a schematic block diagram of a wireless communication device according to some other embodiments of the present disclosure;

FIG. 16 is a flowchart illustrating a method performed by a UE according to some embodiments of the present disclosure; and

FIG. 17 is a flowchart illustrating a method performed by a network node according to some embodiments of the present disclosure.

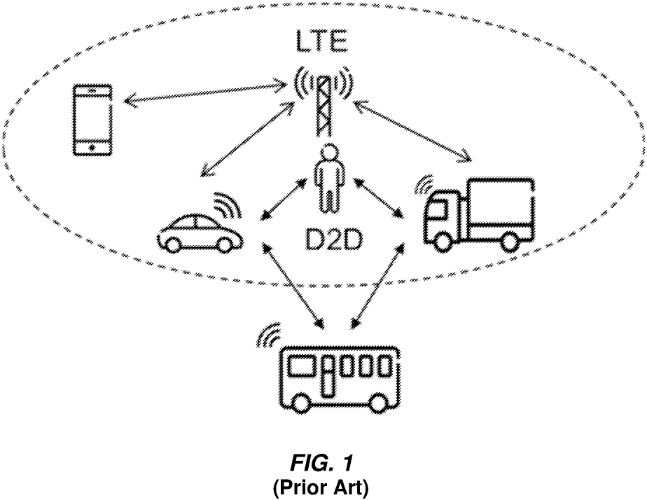

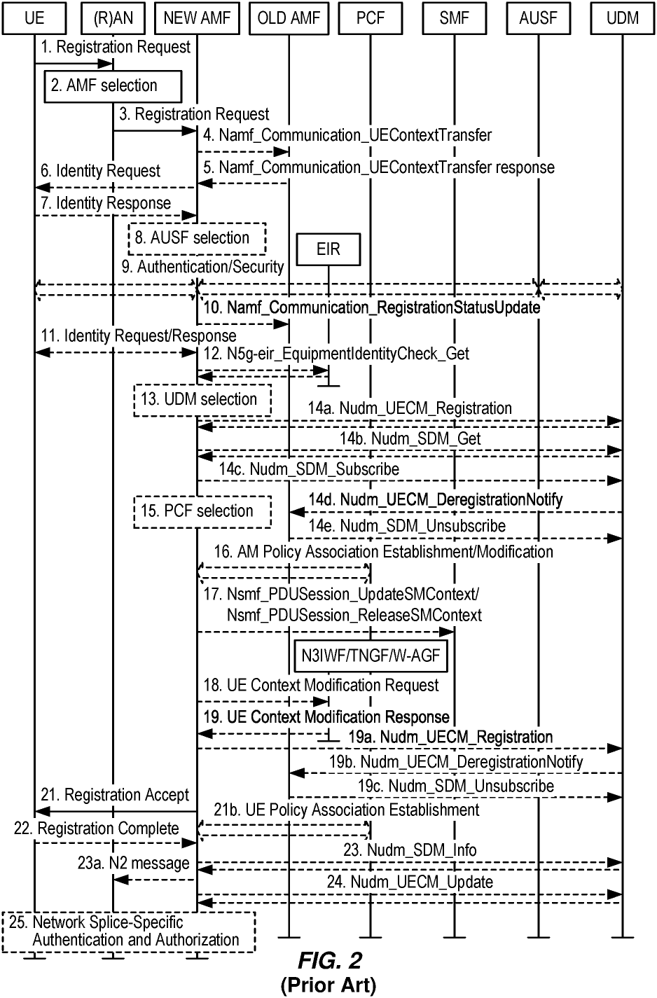

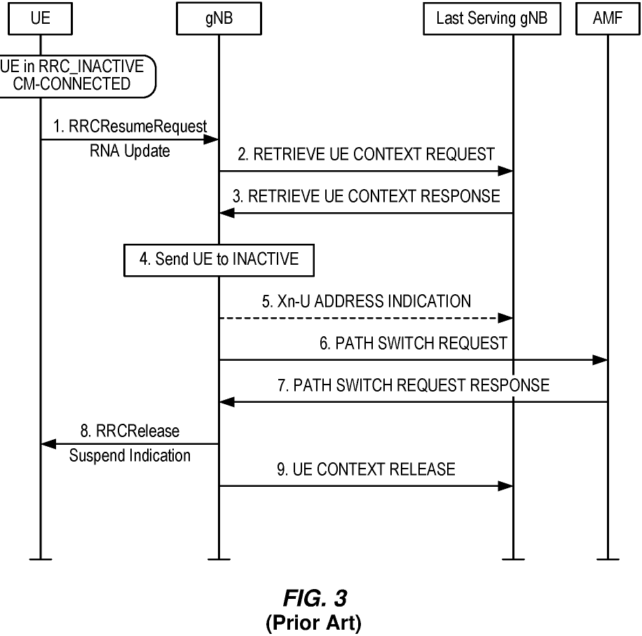

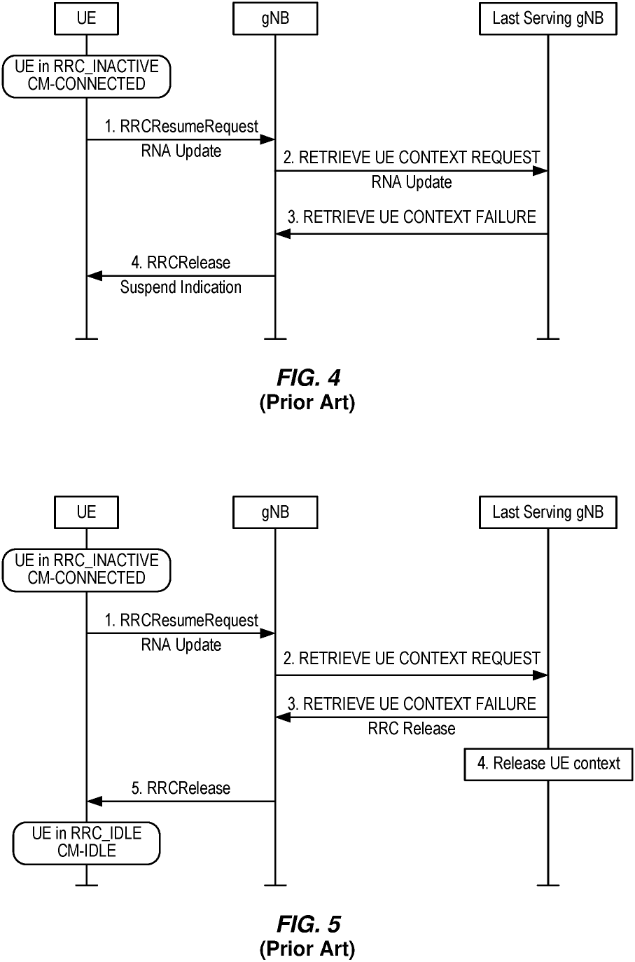

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment (UE) device in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

### Problems With Existing Solutions

There currently exist certain challenge(s). In case of a sidelink relay scenario, a Remote (RM) UE sends/receives packets to/from a network via a Relay (RL) UE. When the RL UE changes its Tracking Area (TA) or Radio Notification Area (RNA), the new gNB (AMF) fetches the UE context of the RL UE. However, if the RM UE has not changed its RNA or TA, and thus has not triggered any TA update or RNA update procedure, the new gNB cannot fetch the UE context of the RM UE from the old gNB (AMF). The same situation can occur when the RM UE changes its TA or RNA but the RL UE does not.

If the new gNB (AMF) is not able to fetch the UE context of both the RM UE and RL UE from the old gNB (AMF), the sidelink relay path may be released, causing a connectivity interruption. Additionally, the release of the sidelink relay path also leads to an increase in signaling overhead, as the sidelink relay path should be re-established from scratch once it is released. This increase in signaling overhead is further exacerbated by the new gNB (AMF) unnecessarily fetching the context of a UE that will not be used later.

### Brief Summary of Some Aspects of the Proposed Solutions

Certain aspects of the present disclosure and their embodiments may provide solutions to the aforementioned or other challenges. Methods and solutions are described herein to allow a new managing network node (e.g., New Radio (NR) Base Station (gNB) or Access and Mobility Management Function (AMF)), in case a Remote (RM)/Relay (RL) User Equipment (UE) changes its Tracking Area (TA) or Radio Access Network (RAN) Notification Area (RNA), to fetch the UE context of both UEs. In doing this the following solutions are proposed.

If the RL UE or RM UE trigger a TA update or RNA update procedure due to a change in its TA or RNA, when sending the Access Stratum (AS) (or Non-Access Stratum (NAS)) message to the managing network node (e.g., gNB or AMF), it includes the information of both UEs (e.g., the RL UE and RM UE).

The new managing network node (e.g., gNB or AMF), upon receiving the TA update or RNA update from the RL UE or RM UE, fetches the UE context from the old managing network node (e.g., gNB or AMF) of both UEs within the same message.

According to the following, the UE context for the RM UE/RL UE performing sidelink relay is correctly stored at the managing network node (e.g., gNB or AMF). Further, the sidelink path does not need to be released since the new managing network node (e.g., gNB or AMF) is aware that there is a sidelink relay connection ongoing and can send necessary configuration to maintain it.

There are, proposed herein, various embodiments which address one or more of the issues disclosed herein. In some embodiments, a method is performed by a UE for context management in a sidelink relay scenario, the method comprising one or more of: initiating an RNA update with a managing network node; and sending UE identities for a sidelink relay to the managing network node, wherein: the UE identities comprises both a RM UE identity of a RM UE in the sidelink relay and a RL UE identity of a RL UE in the sidelink relay; and the UE is either the RM UE or the RL UE.

In some embodiments, the RNA update is initiated in response to the UE experiencing a change of RNA.

In some embodiments, the RNA update is initiated in response to the UE experiencing a cell reselection for a cell that does not belong to a configured RNA.

In some embodiments, the RM UE is the RL UE; and the method further comprises requesting the RM UE identity from the RM UE in the sidelink relay. In some embodiments, the method further comprises receiving the RM UE identity before sending the UE identities for the sidelink relay to the managing network node.

In some embodiments, initiating the RNA update with the managing network node comprises sending a message to the managing network node comprising an RNA update cause value and at least one of the UE identities. In some embodiments, the message to the managing network node comprises an RRCResumeRequest message. In some embodiments, the method further comprises sending an additional message to the managing network node comprising another of the UE identities. In some embodiments, the method further comprises requesting the other UE identity from a corresponding UE in the sidelink relay; and receiving the other UE identity before sending the additional message to the managing network node.

In some embodiments, the method further comprises generating a UE identity mapping for the UE and one or more RM UE identities corresponding to one or more RM UEs in sidelink relays with the UE. In some embodiments, sending the UE identities for the sidelink relay to the managing network node comprises sending the UE identity mapping to the managing network node. In some embodiments, sending the UE identity mapping to the managing network node comprises sending the UE identity mapping periodically. In some embodiments, sending the UE identity mapping to the managing network node comprises sending the UE identity mapping in response to a triggering event. In some embodiments, sending the UE identity mapping to the managing network node comprises sending the UE identity mapping in response to receiving a UE identity request from the managing network node.

In some embodiments, initiating the RNA update comprises sending an RRCResumeRequest message to the managing network node.

In some embodiments, the method further comprises requesting the one or more RM UE identities from the one or more RM UEs in the sidelink relays with the UE; receiving (1006) the one or more RM UE identities; and updating the UE identity mapping in response to receiving the one or more RM UE identities.

In some embodiments, the managing network node comprises a gNB.

In some embodiments, the managing network node comprises an AMF.

In some embodiments, a method is performed by a network node for context management in a sidelink relay scenario, the method comprising one or more of: receiving UE identities for a sidelink relay between a RM UE and a RL UE from the RL UE or the RM UE; receiving an initiation of an RNA update from the RL UE or the RM UE; and managing a UE context for the sidelink relay using the UE identities in response to the initiation of the RNA update.

In some embodiments, managing the UE context for the sidelink relay using the UE identities comprises sending a retrieve UE context request to a last managing network node serving the RL UE or the RM UE. In some embodiments, the retrieve UE context request comprises an RNA update cause value and at least one of the UE identities. In some embodiments, managing the UE context for the sidelink relay using the UE identities further comprises sending an additional retrieve UE context request to the last managing network node comprising another of the UE identities. In some embodiments, managing the UE context for the sidelink relay using the UE identities further comprises receiving a retrieve UE context response from the last managing network node comprising at least one of an RL UE context for the RL UE or an RM UE context for the RM UE. In some embodiments, managing the UE context for the sidelink relay using the UE identities further comprises receiving an additional retrieve UE context response from the last managing network node comprising another of the RL UE context for the RL UE and the RM UE context for the RM UE.

In some embodiments, receiving the initiation of the RNA update from the RL UE or the RM UE comprises receiving a message from the RL UE comprising an RNA update cause value and at least one of the UE identities. In some embodiments, the message from the RL UE comprises an RRCResumeRequest message. In some embodiments, the method further comprises receiving an additional message from the RL UE comprising an RM UE identity from the RM UE in the sidelink relay.

In some embodiments, receiving the UE identities for the sidelink relay comprises receiving a UE identity mapping for an RL UE identity of the RL UE and one or more RM UE identities of one or more RM UEs in sidelink relays with the RL UE. In some embodiments, the method further comprises sending a UE identity request to the RL UE; and receiving the UE identity mapping in response to the UE identity request. In some embodiments, receiving the UE identity mapping comprises receiving the UE identity mapping from the RL UE periodically. In some embodiments, receiving the initiation of the RNA update from the RL UE comprises receiving an RRCResumeRequest message from the RL UE.

In some embodiments, a UE for context management in a sidelink relay scenario is provided, the UE comprising: processing circuitry configured to perform any of the steps of any of the above embodiments; and power supply circuitry configured to supply power to the UE.

In some embodiments, a network node for context management in a sidelink relay scenario is provided, the network node comprising: processing circuitry configured to perform any of the steps of any of the above embodiments; and power supply circuitry configured to supply power to the network node.

Certain embodiments may provide one or more of the following technical advantage(s). The disclosed methods and solutions guarantee that the UE context for the RM UE/RL UE performing sidelink relay is correctly stored at the managing network node (e.g., gNB or AMF). This means that the RRC status of the RM UE or RL UE does not need to be changed and the sidelink path does not need to be released since the new managing network node (e.g., gNB or AMF) is aware that there is a sidelink relay connection ongoing and can send necessary configuration to maintain it. Therefore, connectivity interruption and increased signaling overhead are reduced/avoided, which further results in reduced energy and battery consumption.

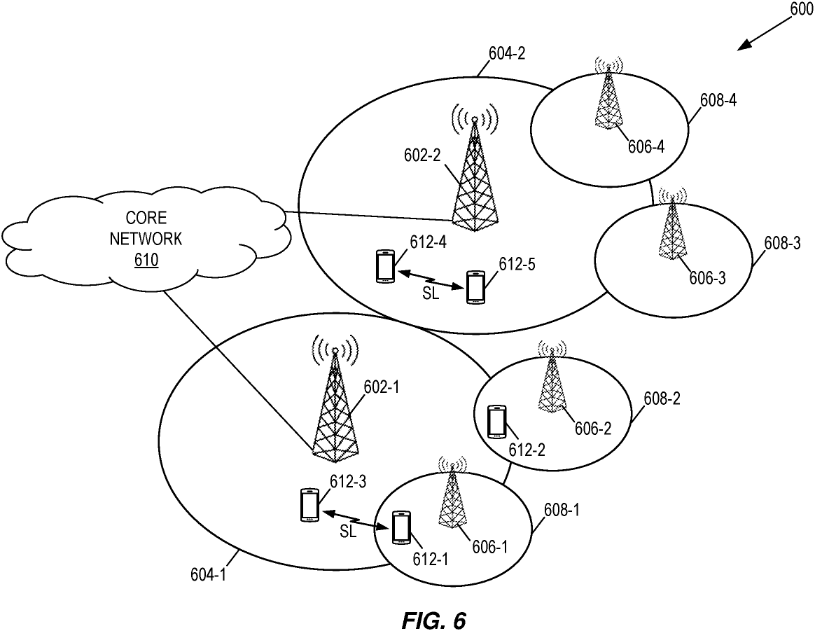

FIG. 6 illustrates one example of a cellular communications system 600 in which embodiments of the present disclosure may be implemented. In the embodiments described herein, the cellular communications system 600 is a 5G system (5GS) including a Next Generation RAN (NG-RAN) and a 5G Core (5GC) or an Evolved Packet System (EPS) including an Evolved Universal Terrestrial RAN (E-UTRAN) and an Evolved Packet Core (EPC). In this example, the RAN includes base stations 602-1 and 602-2, which in the 5GS include NR base stations (gNBs) and optionally next generation eNBs (ng-eNBs) (e.g., LTE RAN nodes connected to the 5GC) and in the EPS include eNBs, controlling corresponding (macro) cells 604-1 and 604-2. The base stations 602-1 and 602-2 are generally referred to herein collectively as base stations 602 and individually as base station 602. Likewise, the (macro) cells 604-1 and 604-2 are generally referred to herein collectively as (macro) cells 604 and individually as (macro) cell 604. The RAN may also include a number of low power nodes 606-1 through 606-4 controlling corresponding small cells 608-1 through 608-4. The low power nodes 606-1 through 606-4 can be small base stations (such as pico or femto base stations) or Remote Radio Heads (RRHs), or the like. Notably, while not illustrated, one or more of the small cells 608-1 through 608-4 may alternatively be provided by the base stations 602. The low power nodes 606-1 through 606-4 are generally referred to herein collectively as low power nodes 606 and individually as low power node 606. Likewise, the small cells 608-1 through 608-4 are generally referred to herein collectively as small cells 608 and individually as small cell 608. The cellular communications system 600 also includes a core network 610, which in the 5GS is referred to as the 5GC. The base stations 602 (and optionally the low power nodes 606) are connected to the core network 610.

The base stations 602 and the low power nodes 606 provide service to wireless communication devices 612-1 through 612-5 in the corresponding cells 604 and 608. The wireless communication devices 612-1 through 612-5 are generally referred to herein collectively as wireless communication devices 612 and individually as wireless communication device 612. In the following description, the wireless communication devices 612 are oftentimes UEs, but the present disclosure is not limited thereto.

In the embodiments described herein, at least some of the UEs 612 have sidelinks with other UEs 612. These UEs are also referred to herein as “sidelink UEs.” For example, FIG. 6 illustrates a sidelink between UE 612-1 and UE 612-3 and another sidelink between UE 612-4 and UE 612-5. Also, at least some of the UEs 612 are within coverage of the RAN and have cellular links, which are also referred to herein as radio links, such as, e.g., Uu links.

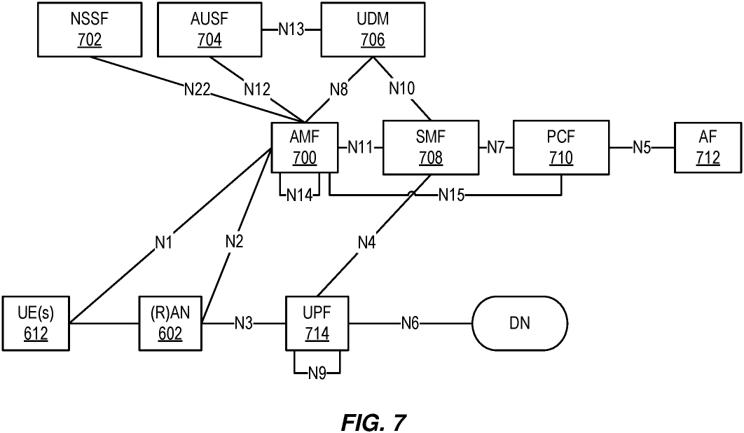

FIG. 7 illustrates a wireless communication system represented as a 5G network architecture composed of core Network Functions (NFs), where interaction between any two NFs is represented by a point-to-point reference point/interface. FIG. 7 can be viewed as one particular implementation of the system 600 of FIG. 6.

Seen from the access side the 5G network architecture shown in FIG. 7 comprises a plurality of UEs 612 connected to either a RAN 602 or an Access Network (AN) as well as an AMF 700. Typically, the (R)AN 602 comprises base stations, e.g. such as eNBs or gNBs or similar. Seen from the core network side, the 5GC NFs shown in FIG. 7 include a NSSF 702, an AUSF 704, a UDM 706, the AMF 700, a SMF 708, a PCF 710, and an Application Function (AF) 712.

Reference point representations of the 5G network architecture are used to develop detailed call flows in the normative standardization. The N1 reference point is defined to carry signaling between the UE 612 and AMF 700. The reference points for connecting between the AN 602 and AMF 700 and between the AN 602 and UPF 714 are defined as N2 and N3, respectively. There is a reference point, N11, between the AMF 700 and SMF 708, which implies that the SMF 708 is at least partly controlled by the AMF 700. N4 is used by the SMF 708 and UPF 714 so that the UPF 714 can be set using the control signal generated by the SMF 708, and the UPF 714 can report its state to the SMF 708. N9 is the reference point for the connection between different UPFs 714, and N14 is the reference point connecting between different AMFs 700, respectively. N15 and N7 are defined since the PCF 710 applies policy to the AMF 700 and SMF 708, respectively. N12 is required for the AMF 700 to perform authentication of the UE 612. N8 and N10 are defined because the subscription data of the UE 612 is required for the AMF 700 and SMF 708.

The 5GC network aims at separating User Plane (UP) and Control Plane (CP). The UP carries user traffic while the CP carries signaling in the network. In FIG. 7, the UPF 714 is in the UP and all other NFs, i.e., the AMF 700, SMF 708, PCF 710, AF 712, NSSF 702, AUSF 704, and UDM 706, are in the CP. Separating the UP and CP guarantees each plane resource to be scaled independently. It also allows UPFs to be deployed separately from CP functions in a distributed fashion. In this architecture, UPFs may be deployed very close to UEs to shorten the Round Trip Time (RTT) between UEs and data network for some applications requiring low latency.

The 5GC network architecture is composed of modularized functions. For example, the AMF 700 and SMF 708 are independent functions in the CP. Separated AMF 700 and SMF 708 allow independent evolution and scaling. Other CP functions like the PCF 710 and AUSF 704 can be separated as shown in FIG. 7. Modularized function design enables the 5GC network to support various services flexibly.

Each NF interacts with another NF directly. It is possible to use intermediate functions to route messages from one NF to another NF. In the CP, a set of interactions between two NFs is defined as service so that its reuse is possible. This service enables support for modularity. The UP supports interactions such as forwarding operations between different UPFs.

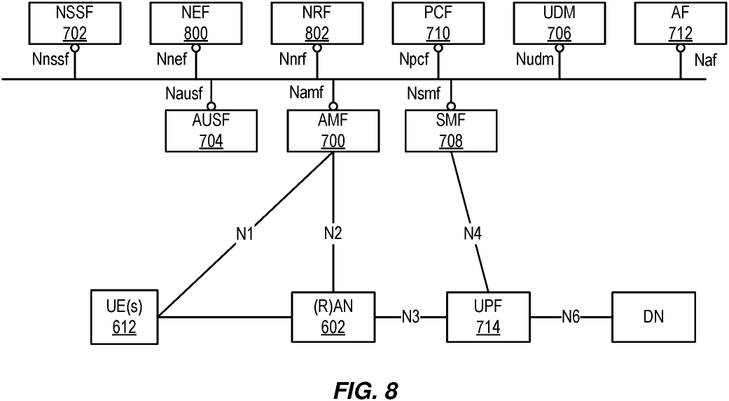

FIG. 8 illustrates a 5G network architecture using service-based interfaces between the NFs in the CP, instead of the point-to-point reference points/interfaces used in the 5G network architecture of FIG. 7. However, the NFs described above with reference to FIG. 7 correspond to the NFs shown in FIG. 8. The service(s) etc. that a NF provides to other authorized NFs can be exposed to the authorized NFs through the service-based interface. In FIG. 8 the service based interfaces are indicated by the letter “N” followed by the name of the NF, e.g. Namf for the service based interface of the AMF 700 and Nsmf for the service based interface of the SMF 708, etc. An NEF 800 and an NRF 802 in FIG. 8 are not shown in FIG. 7 discussed above. However, it should be clarified that all NFs depicted in FIG. 7 can interact with the NEF 800 and the NRF 802 of FIG. 8 as necessary, though not explicitly indicated in FIG. 7.

Some properties of the NFs shown in FIGS. 7 and 8 may be described in the following manner. The AMF 700 provides UE-based authentication, authorization, mobility management, etc. A UE 612 even using multiple access technologies is basically connected to a single AMF 700 because the AMF 700 is independent of the access technologies. The SMF 708 is responsible for session management and allocates IP addresses to UEs. It also selects and controls the UPF 714 for data transfer. If a UE 612 has multiple sessions, different SMFs 708 may be allocated to each session to manage them individually and possibly provide different functionalities per session. The AF 712 provides information on the packet flow to the PCF 710 responsible for policy control in order to support QoS. Based on the information, the PCF 710 determines policies about mobility and session management to make the AMF 700 and SMF 708 operate properly. The AUSF 704 supports authentication function for UEs or similar and thus stores data for authentication of UEs or similar while the UDM 706 stores subscription data of the UE 612. The Data Network (DN), not part of the 5GC network, provides Internet access or operator services and similar.

An NF may be implemented either as a network element on a dedicated hardware, as a software instance running on a dedicated hardware, or as a virtualized function instantiated on an appropriate platform, e.g., a cloud infrastructure.

Now, a description of some example embodiments of the present disclosure will be provided. Note that the following embodiments are described with reference to the NR RAT but can also be applied to LTE RAT and any other RAT enabling the transmission on two nearby devices without any loss of meaning. Further, a RM UE refers to a sidelink UE that needs to transmit/receive packets from/to the gNB via an intermediate network node/mobile terminal, referred to as a RL UE.

Some embodiments described herein target a scenario when the RM UE or RL UE changes RAN Notification Area (RNA) or Tracking Area (TA) or reselects a cell that does not belong to the configured RNA/TA and needs to inform the new managing network node (e.g., gNB or AMF). Upon receiving this update, the new managing network node (e.g., gNB or AMF) fetches the UE context from the old managing network node (e.g., gNB or AMF). Also, message exchanges between the UE and managing network node are referred to as message(s) and those exchanged between the UE and core network are referred to as NAS message(s).

Further, in case of RNA update procedure, the RM UE or RL UE informs the gNB, while in case of TA update procedure the AMF (core network) is informed. In the following the term RNA can be exchanged without any loss of meaning with the term TA and the term gNB can be exchanged without any loss of meaning with the term AMF. Further, the term RL UE can be exchanged without any loss of meaning with RM UE and vice versa. Finally, the term AS and NAS can be also exchanged without any loss of meaning.

Some UE related embodiments are as follows. In one embodiment, upon change of RNA or upon reselecting a cell that does not belong to the configured RNA, when triggering the RNA update towards the new gNB, the RL UE includes in the same AS message (e.g., via the RRCResumeRequest) both its UE identity and the UE identity of the RM UE. In another embodiment, upon change of RNA or upon reselecting a cell that does not belong to the configured RNA, when triggering the RNA update towards the new gNB, the RL UE sends two separate AS message to the gNB, one containing its UE identity and another one containing the RM UE identity.

In one embodiment, the UE identity may be represented by one or a combination of the following parameters:
Radio Network Temporary Identifier (RNTI);
Radio Layer 2 (L2) destination Identifier (ID);
L2 source ID;
plmn-Identity;
cellIdentity;
trackingAreaCode; or
any other UE identity assigned by the gNB or core network.

In another embodiment, the RL UE keeps a mapping of its UE identity and each RM UE identity and sends this mapping periodically to the network. Yet, in another embodiment, the RL UE keeps a mapping of its UE identity and each RM UE identity and sends this mapping only when a new RM UE is added. Further, in another embodiment, the RL UE keeps a mapping of its UE identity and each RM UE identity and sends this mapping to the network only when the network asks for it. Note that according to these embodiments, the RL UE will not send any RM UE identity to the network when triggering the RNA update since the mapping between the RL UE identity and RM UE identity is already known at the network side.

In one embodiment, before triggering the RNA update procedure, the RL UE sends a message to the RM UE for fetching its UE identity (if the UE identity is not known by the RL UE). In another embodiment, upon receiving a request from RL UE to know the UE identity, the RM UE sends its UE identity to the RL UE.

Some network related embodiments are as follows. In one embodiment, upon receiving an AS message with a cause set to RNA update and with more than one UE identity (one for the RL UE and one for the RM UE), the new gNB sends a message to the old gNB by including both the RL UE and RM UE identities (i.e., a list of UE identities are included in the same message). In another embodiment, upon receiving an AS message with a cause set to RNA update and with more than one UE identity (one for the RL UE and one for the RM UE), the new gNB triggers a UE context retrieve procedure for each of the UE identities received (one message for each identity).

In another embodiment, upon receiving a UE context retrieve request from the new gNB, the old gNB sends a message to the new gNB by including both the RL UE and RM UE identities (i.e., a list of UE identities are included in the same message). In another embodiment, upon receiving a UE context retrieve request from the new gNB, the old gNB sends a message to the new gNB for each identity included in the request (i.e., one message for each identity).

In one embodiment, UE context signaling exchange between the new gNB and old gNB (and vice versa), is done by mean of Xn/X2 signaling. Yet, in another embodiment, UE context signaling exchange between the new gNB and old gNB (and vice versa), is done by mean of inter-node RRC signaling.

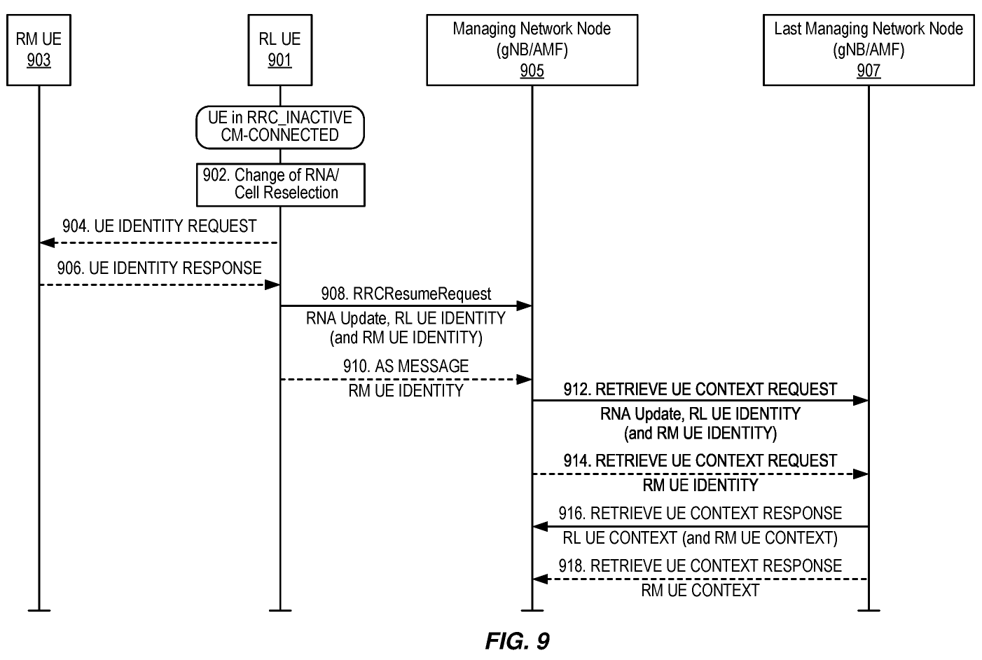

FIG. 9 is a flow diagram illustrating operation of the cellular communications system 600 of FIG. 6 in accordance with at least some of the embodiments described above. As illustrated, a RL UE 901 has a sidelink with a RM UE 903.

At step 902, the RL UE 901 experiences a change of RNA or reselection of a cell that does not belong to the configured RNA.

At step 904, optionally, the RL UE 901 requests a UE identify from the RM UE 903. For example, the RM UE 903 can be the RL UE 901, and the RM UE identity can be requested from the RM UE 903 in the sidelink relay.

At step 906, optionally, the RM UE responds with its UE identity. For example, in some embodiments, in response to the RL UE 901 requesting the UE identify from the RM UE 903 at step 904, the RM UE 903 receives the RM UE identity before sending the UE identities for the sidelink relay to the managing network node 905.

At step 908, the RL UE 901 resumes from RRC_INACTIVE, providing the Inactive Radio Network Temporary Identifier (I-RNTI) allocated by the last serving managing network node 905 (e.g., gNB or AMF), an RNA update cause value, the RL UE identity, and optionally the RM UE identity. More specifically, the RL UE 901 initiates the RAN update with the managing network node 905. The RL UE 901 then sends UE identities for a sidelink relay to the managing network node. The UE identities include both a RM UE identity of a RM UE in the sidelink relay, and a RL UE identity of a RL UE in the sidelink relay. The UE is either the RM UE 903 or the RL UE 901. In some embodiments, to initiate the RNA update with the managing network node 905, a message (e.g., a RRCResumeRequest message, etc.) is sent to the managing network node 905 including an RNA update cause value and at least one of the UE identities.

In some embodiments, the RNA update is initiated by the RL UE 901 in response to the UE experiencing the change of RNA as described with regards to step 902. Alternatively, or additionally, in some embodiments, the RNA update is initiated by the RL UE 901 in response to the UE experiencing a cell reselection for a cell that does not belong to a configured RNA as described with regards to step 902.

At step 910, optionally, the RL UE identity provides the RM UE identity in a separate AS message. For example, an additional message can be sent to the managing network node 905 that includes another of the UE identities.

At step 912, the managing network node 905 (e.g., gNB or AMF) requests the last serving managing network node 907(e.g., gNB or AMF) to provide UE Context, providing the RNA update cause value, the RL UE identity, and optionally the RM UE identity.

At step 914, optionally, the managing network node 905 requests the last serving managing network node 907 to provide UE Context for the RM UE identity in a separate message.

At step 916, the last serving managing network node provides the RM UE context and optionally the RL UE context.

At step 918, optionally, the last serving managing network node provides the RL UE context in a separate message.

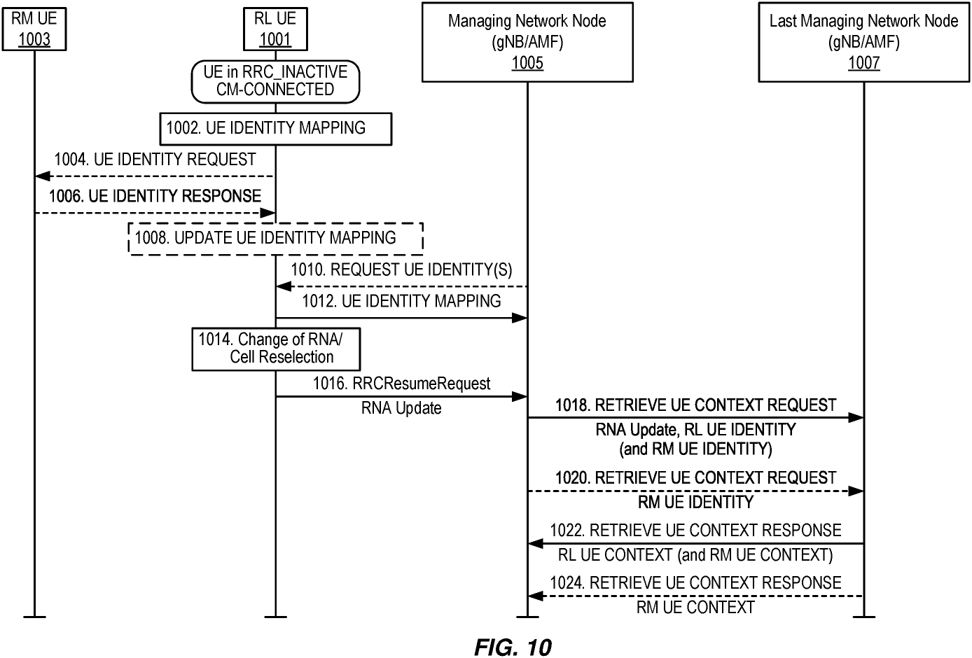

FIG. 10 is a flow diagram illustrating operation of the cellular communications system 600 of FIG. 6 in accordance with at least some of the embodiments described above. As in FIG. 9, the RL UE 1001 has a sidelink with the RM UE 1003.

At step 1002, the RL UE 1001 generates a UE identity mapping of its UE identity and each RM UE identity. For example, the UE identity mapping can be or otherwise represent a mapping for the UE and one or more RM UE identities corresponding to one or more RM UEs in sidelink relays to the UE (e.g., RL UE 1001, etc.).

At step 1004, optionally, the RL UE 1001 may request a UE identity from each RM UE (e.g., periodically or in response to a triggering event such as when a new RM UE is added).

At step 1006, optionally, the RL UE 1001 may receive a response.

At step 1008, optionally, the RL UE 1001 updates the UE identity mapping.

At step 1010, optionally, the RM UE 1003 sends the UE identity mapping in response to a request from the managing network node 1005. Alternatively, or additionally, in some embodiments the RM UE 1003 sends the UE identity mapping in response to a triggering event (e.g., when a new RM UE is added, etc.).

At step 1012, the RM UE 1003 sends the UE identity mapping to the managing network node 1005 periodically or in response to a triggering event (e.g., when a new RM UE is added) (step 1012) and may optionally send the UE identity mapping in response to a request from the managing network node (step 1010).

At step 1014, the RL UE 1001 experiences a change of RNA or reselection of a cell that does not belong to the configured RNA.

At step 1016, the RL UE 1001 resumes from RRC_INACTIVE, providing the I-RNTI allocated by the last serving managing network node 1007 (e.g., gNB or AMF) and an RNA update cause value. For example, the RL UE 1001 may send a RRCResumeRequest message to the managing network node 1005 to initiate the RNA update.

At step 1018, the managing network node 1005 (e.g., gNB or AMF) requests the last serving managing network node 1007 (e.g., gNB or AMF) to provide UE Context, providing the RNA update cause value, the RL UE identity, and optionally, the RM UE identity.

At step 1020, optionally, the managing network node 1005 requests the last serving managing network node 1007 to provide UE Context for the RM UE identity in a separate message.

At step 1022, the last serving managing network node 1007 provides the RM UE context and, optionally, the RL UE context.

At step 1024, optionally, the last serving managing network node 1007 provides the RL UE context in a separate message.

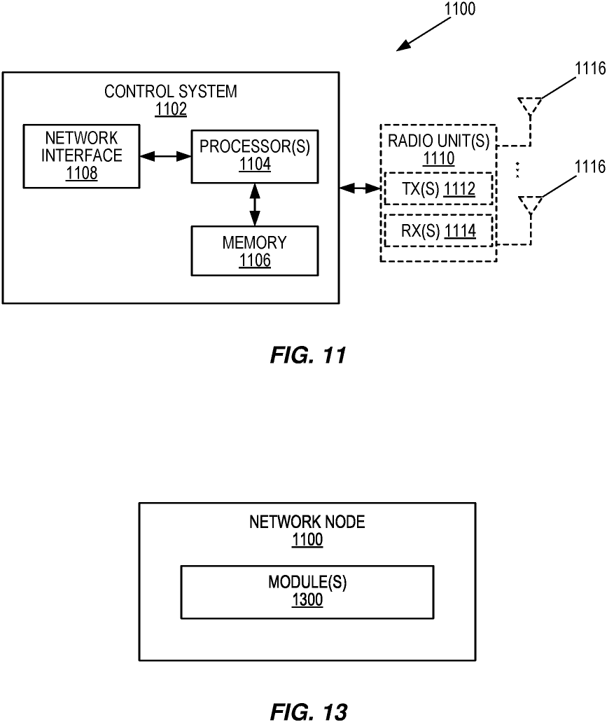

FIG. 11 is a schematic block diagram of a network node 1100 according to some embodiments of the present disclosure. Optional features are represented by dashed boxes. The network node 1100 may be a managing network node, such as a base station 602 or 606 or another network node (e.g., an AMF) which may optionally implement all or part of the functionality of the base station 602 or gNB described herein. As illustrated, the network node 1100 includes a control system 1102 that includes one or more processors 1104 (e.g., Central Processing Units (CPUs), Application Specific Integrated Circuits (ASICs), Field Programmable Gate Arrays (FPGAs), and/or the like), memory 1106, and a network interface 1108. The one or more processors 1104 are also referred to herein as processing circuitry. In addition, the network node 1100 may include one or more radio units 1110 that each includes one or more transmitters 1112 and one or more receivers 1114 coupled to one or more antennas 1116. The radio units 1110 may be referred to or be part of radio interface circuitry. In some embodiments, the radio unit(s) 1110 is external to the control system 1102 and connected to the control system 1102 via, e.g., a wired connection (e.g., an optical cable). However, in some other embodiments, the radio unit(s) 1110 and potentially the antenna(s) 1116 are integrated together with the control system 1102. The one or more processors 1104 operate to provide one or more functions of a network node 1100 as described herein. In some embodiments, the function(s) are implemented in software that is stored, e.g., in the memory 1106 and executed by the one or more processors 1104.

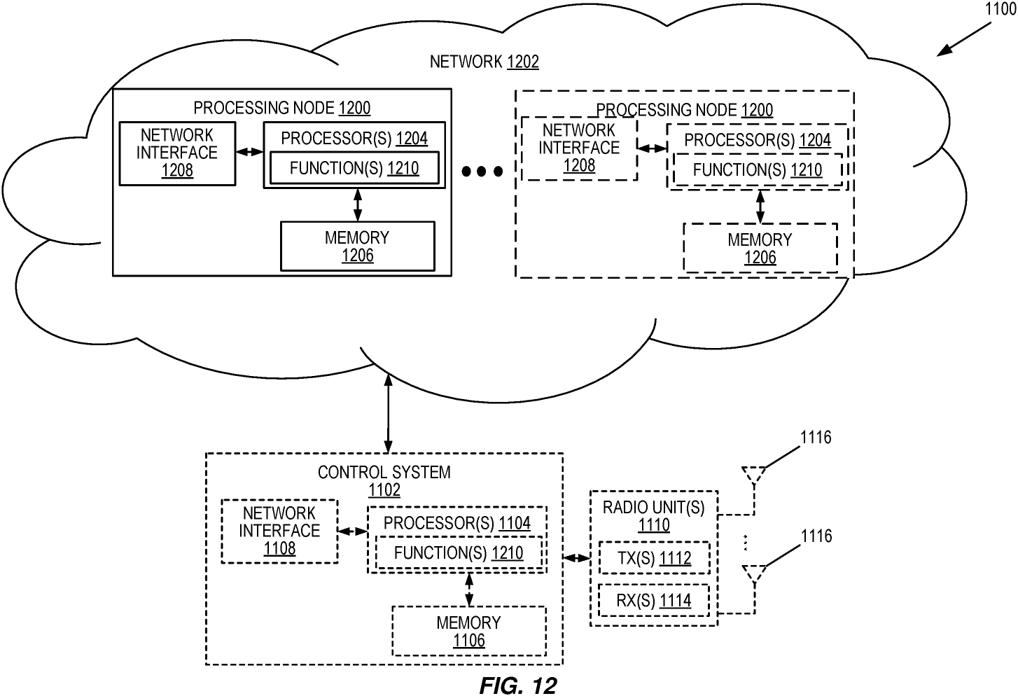

FIG. 12 is a schematic block diagram that illustrates a virtualized embodiment of the network node 1100 according to some embodiments of the present disclosure. This discussion is equally applicable to other types of network nodes. Further, other types of network nodes may have similar virtualized architectures. Again, optional features are represented by dashed boxes.

As used herein, a “virtualized” network node is an implementation of the network node 1100 in which at least a portion of the functionality of the network node 1100 is implemented as a virtual component(s) (e.g., via a virtual machine(s) executing on a physical processing node(s) in a network(s)). As illustrated, in this example, the network node 1100 may include the control system 1102 and/or the one or more radio units 1110, as described above. The control system 1102 may be connected to the radio unit(s) 1110 via, for example, an optical cable or the like. The network node 1100 includes one or more processing nodes 1200 coupled to or included as part of a network(s) 1202. If present, the control system 1102 or the radio unit(s) 1110 are connected to the processing node(s) 1200 via the network 1202. Each processing node 1200 includes one or more processors 1204 (e.g., CPUs, ASICs, FPGAs, and/or the like), memory 1206, and a network interface 1208.

In this example, functions 1210 of the network node 1100 described herein are implemented at the one or more processing nodes 1200 or distributed across the one or more processing nodes 1200 and the control system 1102 and/or the radio unit(s) 1110 in any desired manner. In some particular embodiments, some or all of the functions 1210 of the network node 1100 described herein are implemented as virtual components executed by one or more virtual machines implemented in a virtual environment(s) hosted by the processing node(s) 1200. As will be appreciated by one of ordinary skill in the art, additional signaling or communication between the processing node(s) 1200 and the control system 1102 is used in order to carry out at least some of the desired functions 1210. Notably, in some embodiments, the control system 1102 may not be included, in which case the radio unit(s) 1110 communicate directly with the processing node(s) 1200 via an appropriate network interface(s).

In some embodiments, a computer program including instructions which, when executed by at least one processor, causes the at least one processor to carry out the functionality of network node 1100 or a node (e.g., a processing node 1200) implementing one or more of the functions 1210 of the network node 1100 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 13 is a schematic block diagram of the network node 1100 according to some other embodiments of the present disclosure. The network node 1100 includes one or more modules 1300, each of which is implemented in software. The module(s) 1300 provide the functionality of the network node 1100 described herein. This discussion is equally applicable to the processing node 1200 of FIG. 12 where the modules 1300 may be implemented at one of the processing nodes 1200 or distributed across multiple processing nodes 1200 and/or distributed across the processing node(s) 1200 and the control system 1102.

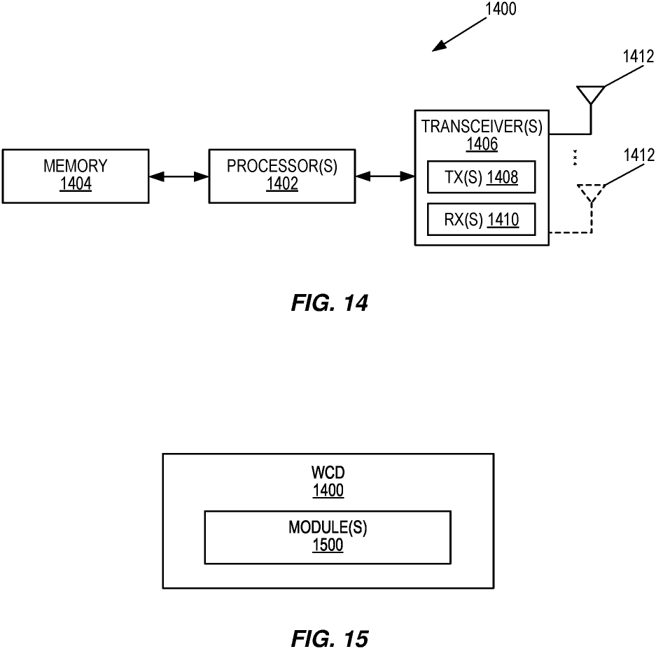

FIG. 14 is a schematic block diagram of a wireless communication device 1400 according to some embodiments of the present disclosure. As illustrated, the wireless communication device 1400 includes one or more processors 1402 (e.g., CPUs, ASICs, FPGAs, and/or the like), memory 1404, and one or more transceivers 1406 each including one or more transmitters 1408 and one or more receivers 1410 coupled to one or more antennas 1412. The transceiver(s) 1406 includes radio-front end circuitry connected to the antenna(s) 1412 that is configured to condition signals communicated between the antenna(s) 1412 and the processor(s) 1402, as will be appreciated by on of ordinary skill in the art. The processors 1402 are also referred to herein as processing circuitry. The transceivers 1406 are also referred to herein as radio circuitry. In some embodiments, the functionality of the wireless communication device 1400 described above may be fully or partially implemented in software that is, e.g., stored in the memory 1404 and executed by the processor(s) 1402. Note that the wireless communication device 1400 may include additional components not illustrated in FIG. 14 such as, e.g., one or more user interface components (e.g., an input/output interface including a display, buttons, a touch screen, a microphone, a speaker(s), and/or the like and/or any other components for allowing input of information into the wireless communication device 1400 and/or allowing output of information from the wireless communication device 1400), a power supply (e.g., a battery and associated power circuitry), etc.

In some embodiments, a computer program including instructions which, when executed by at least one processor, causes the at least one processor to carry out the functionality of the wireless communication device 1400 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 15 is a schematic block diagram of the wireless communication device 1400 according to some other embodiments of the present disclosure. The wireless communication device 1400 includes one or more modules 1500, each of which is implemented in software. The module(s) 1500 provide the functionality of the wireless communication device 1400 described herein.

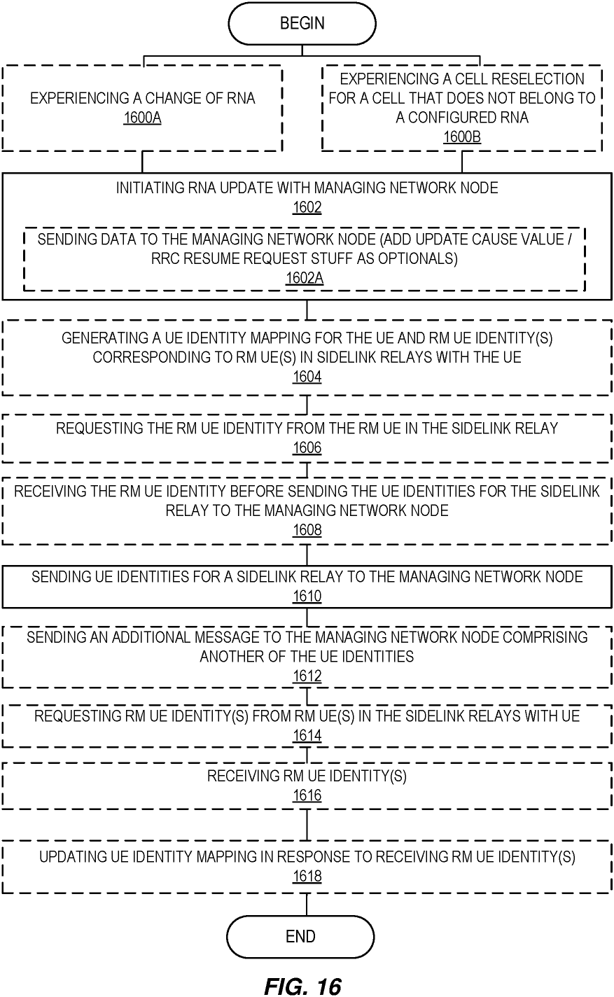

FIG. 16 is a flowchart illustrating a method performed by a UE according to some embodiments of the present disclosure. Optional steps are represented in FIG. 16 by dashed lines/boxes. In this example, the UE is the UE 612.

At step 1600A, in some embodiments, the UE 612 optionally experiences a change of RNA. Alternatively, or additionally, in some embodiments, the UE 612 optionally experiences a cell reselection for a cell that does not belong to a configured RNA.

At step 1602, the UE 612 initiates an RNA update with a managing network node (e.g., a network node managing the UE 612, etc.). In some embodiments, the UE 612 initiates the RNA update in response to experiencing the change of RNA at step 1600A and/or in response to experiencing the cell reselection for the cell that does not belong to a configured RNA at step 1600B.

At step 1602A, in some embodiments, initiating the RNA update optionally includes sending data to the managing network node. In some embodiments, the UE 612 sends data to the managing network node that includes a message. The message includes an RNA update cause value and at least one of the UE identities. For example, the message may be a RRCResumeRequest message.

At step 1604, in some embodiments, the UE 612 optionally generates a UE identity mapping for the UE 612 and one or more RM UE identities corresponding to RM UE(s) in sidelink relays with the UE 612.

At step 1606, in some embodiments, the UE 612 optionally requests the RM UE identity from the RM UE in the sidelink relay. For example, the RM UE may be the RL UE, and the RL UE can request the RM UE identity from the RM UE in the sidelink relay.

At step 1608, in some embodiments, the UE 612 optionally receives the RM UE identity. For example, responsive to requesting the RM UE identity, the UE 612 may receive the RM UE identity before sending UE identities for a sidelink relay to the managing network node (e.g., before the occurrence of step 1610).

At step 1610, the UE 612 sends UE identities for a sidelink relay to the managing network node. In some embodiments, sending the UE identities for the sidelink relay to the managing network node includes sending the UE identity mapping to the managing network node (e.g., the UE identity mapping generated as described with regards to step 1604, etc.). In some embodiments, sending the UE identities for the sidelink relay to the managing network node includes sending the UE identity mapping in response to receiving a UE identity request from the managing network node. In some embodiments, sending the UE identities for the sidelink relay to the managing network node includes sending the UE identity mapping periodically. In some embodiments, sending the UE identities for the sidelink relay to the managing network node includes sending the UE identity mapping in response to a triggering event (e.g., a new RM UE being added, etc.).

At step 1612, in some embodiments, the UE 612 optionally sends an additional message to the managing network node. The additional message includes another of the UE entities.

At step 1614, in some embodiments, the UE 612 optionally requests RM UE identities from one or more RM UEs in the sidelink relays with the UE.

At step 1616, in some embodiments, the UE 612 receives RM UE identities.

At step 1618, in some embodiments, the UE 612 optionally updates the UE identity mapping in response to receiving the one or more RM UE identities.

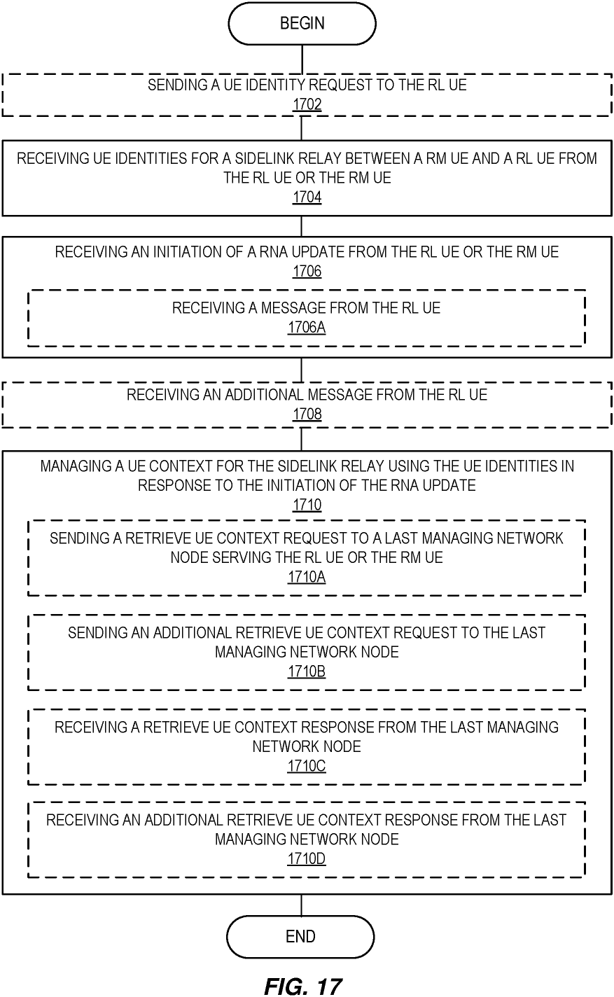

FIG. 17 is a flowchart illustrating a method performed by a network node according to some embodiments of the present disclosure. Optional steps are represented in FIG. 17 by dashed lines/boxes. In this example, the network node is the network 1100.

At step 1702, in some embodiments, the network node optionally 1100 sends a UE identity request to a RL UE.

At step 1704, the network node 1100 receives UE identities for a sidelink relay between a RM UE and a RL UE from the RL UE or the RM UE. In some embodiments, receiving the UE identities for the sidelink relay includes receiving a UE identity mapping for an RL UE identity of the RL UE and one or more RM UE identities of one or more RM UEs in sidelink relays with the RL UE. In some embodiments, the network node 1100 sends a UE identity request to the RL UE and receives the UE identity mapping in response to the UE identity request.

In some embodiments, receiving the UE identity mapping includes receiving the UE identity mapping from the RL UE periodically. In some embodiments, receiving the UE identity mapping includes receiving an RRCResumeRequest message from the RL UE.

At step 1706, the network node 1100 receives an initiation of an RNA update from the RL UE or the RM UE. In some embodiments, to receive the initiation of the RNA update, the network node 1100, optionally, receives a message from the RL UE at step 1706A. The message includes an RNA update cause value and at least one of the UE identities. In some embodiments, the message includes a RRCResumeRequest message. At step 1708, in some embodiments, the network node 1100 optionally receives an additional message from the RL UE.

At step 1710, the network node 1100 manages a UE context for the sidelink relay using the UE identities in response to the initiation of the RNA update. At step 1710A, in some embodiments, to manage the UE context, the network node 1100 optionally sends a retrieve UE context request to a last managing network node serving the RL UE or the RM UE. In some embodiments, the retrieve UE context request includes an RNA update cause value and at least one of the UE identities.

At step 1710B, in some embodiments, to manage the UE context, the network node 1100 optionally sends a retrieve UE context request to a last managing network node serving the RL UE or the RM UE. At step 1710C, in some embodiments, to manage the UE context, the network node 1100 optionally receives a retrieve UE context response from the last managing network node. The retrieve UE context response includes at least one of a RL UE context for the RL UE or an RM UE context for the RM UE. At step 1710D, in some embodiments, to manage the UE context, the network node optionally receives an additional retrieve UE context response from the last managing network node that includes another of the RL UE context for the RL UE and the RM UE context for the RM UE.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

### Embodiments

### Group A Embodiments

Embodiment 1: a method performed by a UE for context management in a sidelink relay scenario, the method comprising one or more of initiating a RNA update with a managing network node, and sending UE identities for a sidelink relay to the managing network node. The UE identities comprises both a RM UE identity of a RM UE in the sidelink relay and a RL UE identity of a RL UE in the sidelink relay. The UE is either the RM UE or the RL UE.

Embodiment 2: The method of embodiment 1, wherein the RNA update is initiated in response to the UE experiencing a change of RNA.

Embodiment 3: The method of embodiment 1, wherein the RNA update is initiated in response to the UE experiencing a cell reselection for a cell that does not belong to a configured RNA.

Embodiment 4: The method of any of embodiments 1 to 3, wherein the RM UE is the RL UE; and the method further comprises requesting the RM UE identity from the RM UE in the sidelink relay.

Embodiment 5: The method of embodiment 4, further comprising receiving the RM UE identity before sending the UE identities for the sidelink relay to the managing network node.

Embodiment 6: The method of any of embodiments 1 to 5, wherein initiating the RNA update with the managing network node comprises sending a message to the managing network node comprising an RNA update cause value and at least one of the UE identities.

Embodiment 7: The method of embodiment 6, wherein the message to the managing network node comprises an RRCResumeRequest message.

Embodiment 8: The method of any of embodiments 6 to 7, further comprising sending an additional message to the managing network node comprising another of the UE identities.

Embodiment 9: The method of embodiment 8, further comprising requesting the other UE identity from a corresponding UE in the sidelink relay; and receiving the other UE identity before sending (908) the additional message to the managing network node.

Embodiment 10: The method of any of embodiments 1 to 5, further comprising generating a UE identity mapping for the UE and one or more RM UE identities corresponding to one or more RM UEs in sidelink relays with the UE.

Embodiment 11: The method of embodiment 10, wherein sending the UE identities for the sidelink relay to the managing network node comprises sending the UE identity mapping to the managing network node.

Embodiment 12: The method of embodiment 11, wherein sending the UE identity mapping to the managing network node comprises sending the UE identity mapping periodically.

Embodiment 13: The method of embodiment 11, wherein sending the UE identity mapping to the managing network node comprises sending the UE identity mapping in response to a triggering event.

Embodiment 14: The method of embodiment 11, wherein sending the UE identity mapping to the managing network node comprises sending the UE identity mapping in response to receiving a UE identity request from the managing network node.

Embodiment 15: The method of any of embodiments 10 to 14, wherein initiating the RNA update comprises sending an RRCResumeRequest message to the managing network node.

Embodiment 16: The method of any of embodiments 10 to 15, further comprising requesting the one or more RM UE identities from the one or more RM UEs in the sidelink relays with the UE; receiving the one or more RM UE identities; and updating the UE identity mapping in response to receiving the one or more RM UE identities.

Embodiment 17: The method of any of embodiments 1 to 16, wherein the managing network node comprises a gNB.

Embodiment 18: The method of any of embodiments 1 to 16, wherein the managing network node comprises an AMF.

### Group B Embodiments

Embodiment 19: A method performed by a network node for context management in a sidelink relay scenario, the method comprising one or more of receiving UE identities for a sidelink relay between a RM UE and a RL UE from the RL UE or the RM UE; receiving an initiation of an RNA update from the RL UE or the RM UE; and managing a UE context for the sidelink relay using the UE identities in response to the initiation of the RNA update.

Embodiment 20: The method of embodiment 19, wherein managing the UE context for the sidelink relay using the UE identities comprises sending a retrieve UE context request to a last managing network node serving the RL UE or the RM UE.

Embodiment 21: The method of embodiment 20, wherein the retrieve UE context request comprises an RNA update cause value and at least one of the UE identities.

Embodiment 22: The method of embodiment 21, wherein managing the UE context for the sidelink relay using the UE identities further comprises sending an additional retrieve UE context request to the last managing network node comprising another of the UE identities.

Embodiment 23: The method of any of embodiments 20 to 22, wherein managing the UE context for the sidelink relay using the UE identities further comprises receiving a retrieve UE context response from the last managing network node comprising at least one of an RL UE context for the RL UE or an RM UE context for the RM UE.

Embodiment 24: The method of embodiment 23, wherein managing the UE context for the sidelink relay using the UE identities further comprises receiving an additional retrieve UE context response from the last managing network node comprising another of the RL UE context for the RL UE and the RM UE context for the RM UE.

Embodiment 25: The method of any of embodiments 19 to 24, wherein receiving the initiation of the RNA update from the RL UE or the RM UE comprises receiving a message from the RL UE comprising an RNA update cause value and at least one of the UE identities.

Embodiment 26: The method of embodiment 25, wherein the message from the RL UE comprises an RRCResumeRequest message.

Embodiment 27: The method of any of embodiments 25 to 26, further comprising receiving an additional message from the RL UE comprising an RM UE identity from the RM UE in the sidelink relay.

Embodiment 28: The method of any of embodiments 19 to 27, wherein receiving the UE identities for the sidelink relay comprises receiving a UE identity mapping for an RL UE identity of the RL UE and one or more RM UE identities of one or more RM UEs in sidelink relays with the RL UE.

Embodiment 29: The method of embodiment 28, further comprising sending a UE identity request to the RL UE; and receiving the UE identity mapping in response to the UE identity request.

Embodiment 30: The method of embodiment 28, wherein receiving the UE identity mapping comprises receiving the UE identity mapping from the RL UE periodically.

Embodiment 31: The method of any of embodiments 28 to 30, wherein receiving the initiation of the RNA update from the RL UE comprises receiving an RRCResumeRequest message from the RL UE.

Embodiment 32: The method of any of embodiments 19 to 31, wherein the network node comprises a gNB.

Embodiment 33: The method of any of embodiments 19 to 31, wherein the network node comprises an AMF.

### Group C Embodiments

Embodiment 34: A UE for context management in a sidelink relay scenario, the UE comprising processing circuitry configured to perform any of the steps of any of the Group A embodiments; and power supply circuitry configured to supply power to the UE.

Embodiment 35: A network node for context management in a sidelink relay scenario, the network node comprising processing circuitry configured to perform any of the steps of any of the Group B embodiments; and power supply circuitry configured to supply power to the network node.

At least some of the following abbreviations may be used in this disclosure. If there is an inconsistency between abbreviations, preference should be given to how it is used above. If listed multiple times below, the first listing should be preferred over any subsequent listing(s).

| | |
|---|---|
| 3GPP | Third Generation Partnership Project |
| 4G | Fourth Generation |
| 5G | Fifth Generation |
| 5GC | Fifth Generation Core |
| 5GS | Fifth Generation System |
| AF | Application Function |
| AMF | Access and Mobility Management Function |
| AN | Access Network |
| AP | Access Point |
| AS | Access Stratum |
| ASIC | Application Specific Integrated Circuit |
| AUSF | Authentication Server Function |
| CN | Core Network |
| CP | Control Plane |
| CPU | Central Processing Unit |
| C-RNTI | Cell Radio Network Temporary Identifier |
| DL | Downlink |
| DN | Data Network |
| DSP | Digital Signal Processor |
| EIR | Equipment Identity Register |
| eNB | Enhanced or Evolved Node B |
| EPC | Evolved Packet Core |
| EPS | Evolved Packet System |
| E-UTRAN | Evolved Universal Terrestrial Radio Access Network |
| FPGA | Field Programmable Gate Array |
| FS | Function Specific |
| gNB | New Radio Base Station |
| gNB-CU | New Radio Base Station Central Unit |
| gNB-DU | New Radio Base Station Distributed Unit |
| GUTI | 5G-Globally Unique Temporary Identifier |
| HPLMN | Home Public Land Mobile Network |
| HSS | Home Subscriber Server |
| ID | Identifier |
| IE | Information Element |
| IEEE | Institute of Electrical and Electronics Engineers |
| IoT | Internet of Things |
| IP | Internet Protocol |
| I-RNTI | Inactive Radio Network Temporary Identifier |
| L1 | Radio Layer 1 |
| L2 | Radio Layer 2 |
| LADN | Local Area Data Network |
| LTE | Long Term Evolution |
| MME | Mobility Management Entity |
| MTC | Machine Type Communication |
| NAS | Non-Access Stratum |
| NEF | Network Exposure Function |
| NF | Network Function |
| NG-RAN | Next Generation Radio Access Network |
| NR | New Radio |
| NRF | Network Function Repository Function |
| NSI | Network Slice Instance |
| NSPF | National Security and Public Safety |
| NSSF | Network Slice Selection Function |
| PC | Personal Computer |
| PCF | Policy Control Function |
| PCI | Physical Cell Identity |
| PEI | Permanent Equipment Identifier |
| P-GW | Packet Data Network Gateway |
| PLMN | Public Land Mobile Network |
| QoS | Quality of Service |
| RAM | Random Access Memory |
| RAN | Radio Access Network |
| RAT | Radio Access Technology |
| RL | Relay |
| RM | Remote |
| RNA | Radio Notification Area |
| RNTI | Radio Network Temporary Identifier |
| ROM | Read Only Memory |
| RRH | Remote Radio Head |
| RSU | Roadside Unite |
| RTT | Round Trip Time |
| SCEF | Service Capability Exposure Function |
| SID | Study Item Description |
| SMF | Session Management Function |
| SUCI | Subscription Concealed Identifier |
| SUPI | Subscription Permanent Identifier |
| TA | Tracking Area |
| TAC | Track Area Code |
| TR | Technical Report |
| TS | Technical Specification |
| UDM | Unified Data Management |
| UDR | Unified Data Repository |
| UE | User Equipment |
| UP | User Plane |
| UPF | User Plane Function |
| Uu | Cellular Interface |
| V2I/N | Vehicle-to-Infrastructure/Network |
| V2P | Vehicle-to-Pedestrian |
| V2V | Vehicle-to-Vehicle |
| V2X | Vehicle-to-Everything |

Those skilled in the art will recognize improvements and modifications to the embodiments of the present disclosure. All such improvements and modifications are considered within the scope of the concepts disclosed herein.

1. A method performed by a User Equipment, UE, for context management in a sidelink relay scenario, the method comprising:
initiating a Radio Access Network, RAN, Notification Area, RNA, update with a managing network node; and
sending UE identities for a sidelink relay to the managing network node, wherein:
the UE identities comprises both a Remote, RM, UE identity of a RM UE in the sidelink relay and a Relay, RL, UE identity of a RL UE in the sidelink relay; and
the UE is either the RM UE or the RL UE.

2. The method of claim 1, wherein the RNA update is initiated in response to the UE experiencing a change of RNA.

3. The method of claim 1, wherein the RNA update is initiated in response to the UE experiencing a cell reselection for a cell that does not belong to a configured RNA.

4. The method of claim 1, wherein:
the UE is the RL UE; and
the method further comprises requesting the RM UE identity from the RM UE in the sidelink relay.

5. The method of claim 4, further comprising receiving the RM UE identity before sending the UE identities for the sidelink relay to the managing network node.

6. The method of claim 1, wherein initiating the RNA update with the managing network node comprises sending a message to the managing network node comprising an RNA update cause value and at least one of the UE identities.

7. The method of claim 6, wherein the message to the managing network node comprises a Radio Resource Control, RRC, RRCResumeRequest message.

8. The method of claim 6, further comprising sending an additional message to the managing network node comprising another of the UE identities.

9. The method of claim 8, further comprising:
requesting the another of the UE identities from a corresponding UE in the sidelink relay; and
receiving the another of the UE identities before sending the additional message to the managing network node.

10. The method of claim 1, further comprising generating a UE identity mapping for the UE and one or more RM UE identities corresponding to one or more RM UEs in sidelink relays with the UE.

11. The method of claim 10, wherein sending the UE identities for the sidelink relay to the managing network node comprises sending the UE identity mapping to the managing network node.

12. The method of claim 11, wherein sending the UE identity mapping to the managing network node comprises sending the UE identity mapping periodically.

13. The method of claim 11, wherein sending the UE identity mapping to the managing network node comprises sending the UE identity mapping in response to a triggering event.

14. The method of claim 11, wherein sending the UE identity mapping to the managing network node comprises sending the UE identity mapping in response to receiving a UE identity request from the managing network node.

15. The method of claim 10, wherein initiating the RNA update comprises sending a Radio Resource Control, RRC, RRCResumeRequest message to the managing network node.

16. The method of claim 10, further comprising:
requesting the one or more RM UE identities from the one or more RM UEs in the sidelink relays with the UE;
receiving the one or more RM UE identities; and
updating the UE identity mapping in response to receiving the one or more RM UE identities.

17. The method of claim 1, wherein the managing network node comprises a New Radio Base Station, gNB.

18. The method of claim 1, wherein the managing network node comprises an Access and Mobility Management Function, AMF.

19. (canceled)

20. (canceled)

21. A User Equipment, UE, for context management in a sidelink relay scenario, the UE comprising:
power supply circuitry configured to supply power to the UE; and
processing circuitry configured to cause the UE to:
i. initiate a Radio Access Network, RAN, Notification Area, RNA, update with a managing network node; and
ii. send UE identities for a sidelink relay to the managing network node, wherein:
1. the UE identities comprises both a Remote, RM, UE identity of a RM UE in the sidelink relay and a Relay, RL, UE identity of a RL UE in the sidelink relay; and
2. the UE is either the RM UE or the RL UE.

22. (canceled)

23. A method performed by a network node for context management in a sidelink relay scenario, the method comprising:
receiving User Equipment, UE, identities for a sidelink relay between a Remote, RM, UE, and a Relay, RL, UE from the RL UE or the RM UE;
receiving an initiation of a Radio Access Network, RAN, Notification Area, RNA, update from the RL UE or the RM UE; and
managing a UE context for the sidelink relay using the UE identities in response to the initiation of the RNA update.

24. The method of claim 23, wherein managing the UE context for the sidelink relay using the UE identities comprises sending a retrieve UE context request to a last managing network node serving the RL UE or the RM UE.

25. The method of claim 24, wherein the retrieve UE context request comprises an RNA update cause value and at least one of the UE identities.

26. The method of claim 25, wherein managing the UE context for the sidelink relay using the UE identities further comprises sending an additional retrieve UE context request to the last managing network node comprising another of the UE identities.

27. The method of claim 24, wherein managing the UE context for the sidelink relay using the UE identities further comprises receiving a retrieve UE context response from the last managing network node comprising at least one of an RL UE context for the RL UE or an RM UE context for the RM UE.

28. The method of claim 27, wherein managing the UE context for the sidelink relay using the UE identities further comprises receiving an additional retrieve UE context response from the last managing network node comprising another of the RL UE context for the RL UE and the RM UE context for the RM UE.

29-39. (canceled)

40. A network node for context management in a sidelink relay scenario, the network node comprising:
power supply circuitry configured to supply power to the network node; and
processing circuitry configured to cause the network node to:
i. receive User Equipment, UE, identities for a sidelink relay between a Remote, RM, UE, and a Relay, RL, UE from the RL UE or the RM UE;
ii. receive an initiation of a Radio Access Network, RAN, Notification Area, RNA, update from the RL UE or the RM UE; and
iii. manage a UE context for the sidelink relay using the UE identities in response to the initiation of the RNA update.

41. (canceled)
